(19) United States
(12) Patent Application Publication
(10) Pub. No.: US 2020/0269715 A1
(43) Pub. Date: Aug. 27, 2020

(54) METHOD AND SYSTEM FOR INTELLIGENTLY MANAGING ELECTROCHEMICAL BATTERIES OF AN ELECTRICAL POWER SUPPLY INSTALLATION

(71) Applicant: BLUE SOLUTIONS, Ergue Gaberic (FR)

(72) Inventors: Christian SELLIN, Concarneau (FR); Jean-Jacques JESTIN, Fouesnant (FR); Yvan AGNUS, Quimper (FR); Dominique HINGANT, Saint Yvi (FR); Tony TAN, Rennes (FR); Gilles BRUNET, Ploneis (FR); Michel THOMAS, Pouldreuzic (FR)

(21) Appl. No.: 16/305,367

(22) PCT Filed: Jun. 2, 2017
(86) PCT No.: PCT/EP2017/063541

§ 371 Date: Nov. 28, 2018

(30) Foreign Application Priority Data
Jun. 16, 2016 (FR) 1655625

(51) Int. Cl. B60L 53/53; B60L 53/31; B60L 53/51; B60L 53/52; H02J 3/38; H02J 7/14

(52) U.S. Cl. CPC B60L 53/53; B60L 53/31; B60L 53/51; B60Y 2200/91; H02J 3/381; H02J 7/1469; H02J 2300/20; B60L 53/52

(57) ABSTRACT

A method for managing a plurality of rechargeable electrical energy storage modules of an electrical power supply installation, which modules are arranged in parallel with one another, the method including: separating the modules into at least two groups; and supplying power from one group at a time; the method including a regulating phase within at least one group, referred to as the passive group, including supplying power to at least one module, referred to as the passive module, of the passive group by at least one other module, referred to as the functional module, of the passive group. Also provided is a system implementing such a method and an electrical power supply installation implementing such a method or system.

The invention relates to a method for intelligently managing the electrochemical batteries of an electrical supply installation. It also relates to a system implementing such a method, and an electrical supply installation implementing such a method or such a system.

The field of the invention is the field of electrical supply installations comprising several electrochemical batteries, in particular of LMP® (for “Lithium Metal Polymer”) type, mounted in parallel, in order to provide a supply signal.

### STATE OF THE ART

Stationary electrical supply installations are known comprising several electricity storage modules mounted in parallel and each comprising one or more electrochemical batteries, in particular of LMP® type. Each module makes it possible to store electrical energy then deliver a high-voltage signal, for example to recharge an electric vehicle or to supply a building.

Certain stationary electrical supply installations are autonomous and couple means for energy production, such as for example solar panels or wind turbines, with electrical energy storage modules, with a view to recharging said modules.

At the same time, it is known that electrochemical batteries are unsuited to slow discharge. In addition, in the case of the batteries of LMP® (for “Lithium Metal Polymer”) type, it is necessary to maintain all the batteries at a minimum operating temperature, in general greater than or equal to 80° C. In addition, when several batteries are used at the same time, it is preferable that each of these batteries has the same remaining charge level.

However, currently, no method exits for managing the rechargeable electrical energy storage modules of an electrical supply installation making it possible to satisfy all of these requirements intelligently.

A purpose of the present invention is to overcome this drawback.

Another purpose of the invention is to propose a method for intelligently managing the electrical energy storage modules, mounted in parallel, of an electrical supply installation mounted in parallel.

It is also a purpose of the invention to propose a method for managing the electrical energy storage modules of an electrical supply installation, mounted in parallel, making it possible to optimize the life span of said modules while maintaining said modules ready for use at any moment.

### Disclosure of the Invention

The invention makes it possible to achieve at least one of these aims by a method for managing a plurality of rechargeable electrical energy storage modules of an electrical supply installation, in particular stationary, said modules each comprising at least one rechargeable electrochemical battery, in particular of LMP® type, and being arranged in parallel with each other, said method comprising:
separating said modules into at least two groups, and
supplying from one of said groups at once, in particular in turn,
and also more particularly alternately; said method comprising, during the supply by one group, called active group, a phase, called regulation phase, within at least one group, called passive group, other than the active group, said regulation phase comprising supplying at least one module of said passive group by at least one other module, called operational module, of said passive group.

Thus, the method according to the invention proposes to separate virtually the rechargeable electrical energy storage modules into several groups, and a use of one group at once for producing a supply, in particular for recharging an electric vehicle, supplying a building, supplying a complex, supplying an electric/electronic device, in particular a communication device such as a Wifi hotspot or an antenna. Thus, it is possible to apply rapid discharge cycles to each group and to optimize the life span of each module.

In addition, when a group called passive group is not used, then a module called operational module, forming part of said passive group, is used for supplying the other modules of this passive group in order to regulate them so as to maintain them ready for use.

In the present application, by “separation” is meant a virtual grouping of the modules, independently of their physical arrangement.

Preferentially, the regulation phase of a passive group can carry out a balancing of the remaining charge level of at least one, and in particular of each, module of said passive group.

For example, the regulation phase can carry out a discharge of the operational module in order to balance its remaining charge level with the remaining charge level of at least one other module of the passive group. In this case, the operational module can be used for supplying, for example, an auxiliary device of the vehicle, in particular external to the passive group.

Alternatively, or in addition, the operational module of the passive group can be used in order to balance the remaining charge levels of the modules of the passive group, for example by supplying at least one other module of the passive group. In this example, the operational module discharges into at least one other module of the passive group in order to recharge said at least one other module of the passive group.

Alternatively, or in addition, the regulation phase of a passive group can carry out temperature maintenance of at least one, in particular of each, module of said passive group.

In other words, the operational module of the passive group can be used for maintaining heated at least one, in particular all the modules of the passive group, including itself, at a temperature greater than or equal to a predetermined temperature.

When the regulation phase of a passive group carries out temperature maintenance, then the operational module of the passive group is used for supplying a heating means, such as a heating resistor, of at least one, in particular of each, module of the passive group, including its own.

According to a particularly preferred version of the method according to the invention, for at least one passive group, the regulation phase can comprise a change-over, in particular in turn, of the operational module within the passive group.

Thus, the method according to the invention allows better managing of the modules of the passive group to be carried out.

Advantageously, the change-over can be carried out as a function of the remaining charge level (RCL) of each of the modules of the passive group.

In particular, the change-over can be carried out when the remaining charge level of the operational module becomes less than or equal to the remaining charge level of another module of the passive group, of a first predetermined value.

Advantageously, the first predetermined value can correspond to a percentage of a maximum charge capacity (MCC), or of a remaining charge level (RCL), of at least one of the modules of the passive group.

According to a first embodiment, the first predetermined value can be constant.

For example, the first predetermined value can be equal to 5% of the MCC of a module.

According to another embodiment, the first predetermined value can be variable.

More particularly, the first predetermined value can be a function of the remaining charge level (RCL) at the level of each module of the passive group.

In particular, the predetermined value can reduce when the remaining charge level (RCL) of each module of the passive group reduces.

According to a non-limitative embodiment, the first predetermined value can be equal to:
5% of the MCC of a module of the passive group when all the modules of said passive group have an RCL greater than 70% of the MCC;
4% of the MCC of a module of the passive group when at least one module of said passive group has an RCL comprised between 50% and 70% of the MCC;
3% of the MCC of a module of the passive group when at least one module of said passive group has an RCL comprised between 30% and 50% of the MCC; and
2% of the MCC of a module of the passive group when at least one module of said passive group has an RCL less than 30% of the MCC.

According to a non-limitative embodiment, the method according to the invention can comprise switching the supply from one group to another, carried out as a function of the remaining charge levels of said groups.

More particularly, the switching of one group to another can be carried out when the remaining charge level of the active group is less than or equal to the remaining charge level of a passive group, in particular of a second predetermined value.

In the case where a continuous supply without micro power outages is desired from the electrical supply installation, the switching can be carried out so as to ensure a continuous supply.

Such switching can be carried out in different ways.

According to a first embodiment, the switching from a first group to a second group can be carried out by connecting the second group before disconnecting the first group, in which case a very short period exists where the supply is ensured by the first and the second group.

According to another embodiment, the switching from a first group to a second group can be carried out by using a third group used for supply solely during the switching, in order to ensure continuity of the supply.

Of course other embodiments are possible.

Advantageously, the second predetermined value can correspond to a percentage of a maximum charge capacity (MCC), or to a remaining charge level (RCL), of at least one of the groups.

According to a first embodiment, the second predetermined value can be constant.

For example, the second predetermined value can be equal to 5% of the MCC of a group.

According to another embodiment, the second predetermined value can be variable.

More particularly, the second predetermined value can be function of the RCL of each group.

In particular, the second predetermined value can reduce when the RCL of each group reduces.

According to a non-limitative embodiment, the second predetermined value can be equal to:
10% of the MCC of a group when all the groups have an RCL greater than 70% of the MCC;
8% of the MCC of a group when at least one group has an RCL comprised between 50%, and 70% of the MCC;
5% of the MCC of a group when at least one group has an RCL comprised between 30% and 50% of the MCC; and
3% of the MCC of a group when at least one group has an RCL less than 30% of the MCC.

In a preferred version, each group can comprise an identical number of modules.

The number of modules can be determined as a function of a desired total power during the supply step and of the power which can be delivered by each module.

In a preferred version, all the modules are identical and each deliver one and the same nominal power.

Advantageously, the operational module of the passive group can moreover be used for the supply of an auxiliary device within the electrical supply installation, internal or external to the passive group.

The method according to the invention can moreover comprise, for each module, a measurement of at least one, in particular of each, of the following parameters:
a remaining charge level (RCL) of said module, for example by a battery fuel gauge;
a temperature of said module, for example by a thermometer or a thermocouple; and/or
a voltage at the terminals of said module, for example by a voltmeter.

At least one of these parameters can be used for determining if a switching, respectively a change-over, to another group, respectively to another module of the passive group, must be carried out or not.

According to another aspect of the same invention, a system for managing a plurality of rechargeable electrical energy storage modules of an electrical supply installation is proposed, in particular stationary, said modules each comprising at least one rechargeable electrochemical battery, in particular of LMP® type, and being arranged in parallel with each other, said system comprising:
for each module, a means for individual connection/disconnection, making it possible to place said module on discharge independently of the other modules, and
at least one group controller for controlling, directly or indirectly, each of said means of connection/disconnection; said group controller being configured for implementing all the steps of the method according to the invention.

According to yet another aspect of the invention, an electrical supply installation is proposed, in particular stationary, comprising a plurality of rechargeable electrical energy storage modules, said modules each comprising at least one rechargeable electrochemical battery, in particular LMP®, and being arranged in parallel with each other, said modules being managed:
according to the method according to the invention; or
by a system according to the invention.

Advantageously, the installation according to the invention can comprise a means for the production of electrical energy from a renewable source, such as at least one solar panel and/or at least one wind turbine.

The energy produced by such a means can be used for recharging at least one rechargeable electrical energy storage module.

Alternatively or in addition, at least one rechargeable electrical energy storage module can be recharged from the power grid.

The electrical supply installation according to the invention can be an electrical recharging station for electric vehicles.

Alternatively, the electrical supply installation according to the invention can be an electrical supply installation for a building such as a cinema, a complex such as a sports ground, or an electric/electronic communication device such as a Wifi hotspot or an antenna, etc.

### DESCRIPTION OF THE FIGURES AND EMBODIMENTS

Other advantages and characteristics of the invention will become apparent on examination of the detailed description of embodiments which are in no way limitative, and the attached drawings, in which:

FIG. 1 is a diagrammatic representation of a non-limitative example of an electrical supply installation according to the invention;

FIGS. 2a and 2b are the diagrammatic representations of two non-limitative examples of the connection in parallel of the electrical energy storage modules of an electrical supply installation according to the invention, and in particular of the installation of FIG. 1;

FIG. 3 is a diagrammatic representation, in the form of a flow chart, of a non-limitative embodiment of the method according to the invention; and

FIGS. 4a-4f are representations of an example of the application of the method of FIG. 3 in the case of the installation of FIG. 1.

It is well understood that the embodiments which will be described hereinafter are in no way limitative. It is possible to envisage variants of the invention comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, the elements common to several figures retain the same reference.

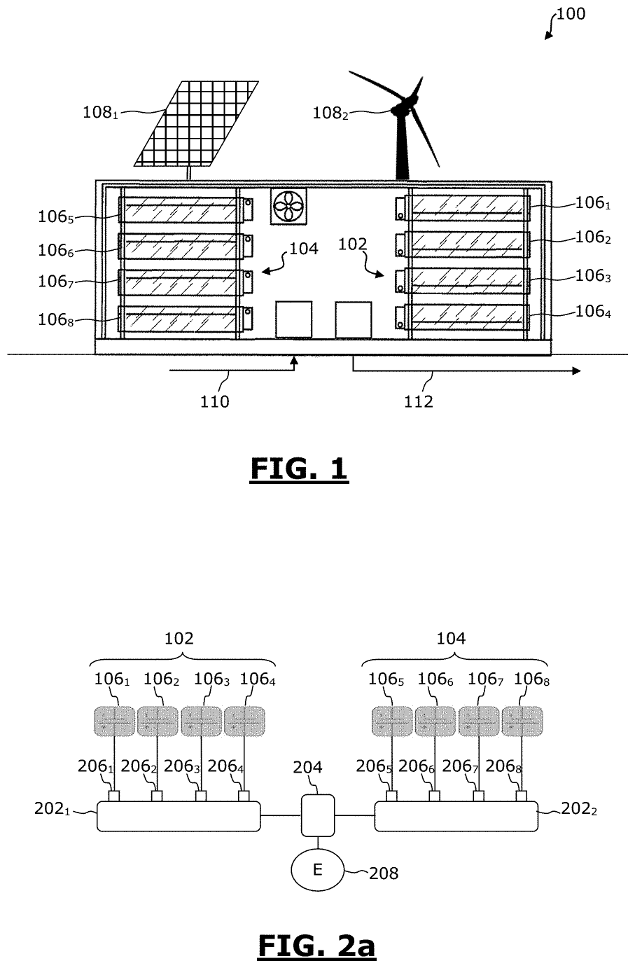

FIG. 1 is a diagrammatic representation of a non-limitative example of an electrical supply installation according to the invention.

The electrical supply installation 100, represented in FIG. 1, can be an electrical recharging station for electric vehicles such as electric buses or electric cars, a supply installation for a building, a complex such as a football ground, a communication device such as a Wifi hotspot or an antenna, etc.

The installation 100 comprises a first group 102 and a second group 104 each comprising four rechargeable electrical energy storage modules, namely the modules 106₁-106₄ for the group 102 and the modules 106₅-106₈ for the group 104.

Each rechargeable electrical energy storage module 106 comprises one or more batteries of LMP® (for “Lithium Metal Polymer”) type. The modules 106 are all identical and provide the same nominal power.

One or more means 108 for producing electrical energy from a renewable source, such as for example solar panels 108₁ or wind turbine(s) 108₂, can be used for recharging the modules 106. The production means 108 may or may not form part of the installation 100.

Alternatively, or in addition, each module 106 can be recharged from an electrical energy distribution grid, shown by the line referenced 110.

The installation 100 makes it possible to supply a charging terminal, a complex, and more generally an entity, via an electricity grid shown by the line referenced 112. One or more group controller make it possible to control the operations of the installation 100.

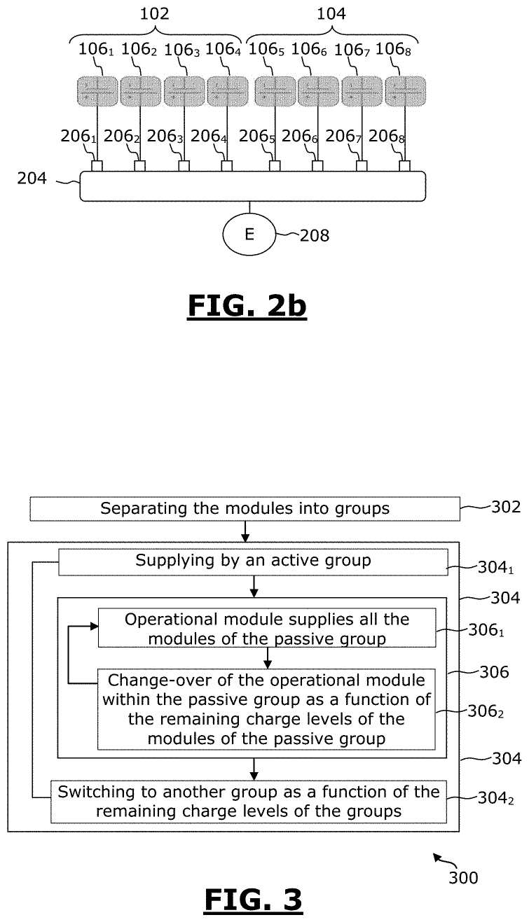

FIG. 2a is a diagrammatic representation of a non-limitative example of the connection in parallel of electrical energy storage modules of an electrical supply installation according to the invention, and in particular of the installation 100 of FIG. 1.

In the example represented in FIG. 2a, the modules 106₁-106₄ of the group 102 are connected to a management module 202₁, also called group control program, and the modules 106₅-106₈ of the group 104 are connected to a management module 202₂, also called group controller.

The group controllers 202₁ and 202₂ are in turn connected to a central controller 204, which is itself connected, directly or indirectly, to a entity 208 to be supplied, denoted “E”, such an entity being able to be an electric vehicle, a building, an electric/electronic device, a Wifi hotspot, an antenna, etc.

In particular, each module 106₁-106₄ of the group 102 is connected to the group controller 202₁ via a contactor, respectively 206₁-206₄, which can be controlled by the group controller 202₁ or by the central controller 204. Similarly, each module 106₅-106₈ of the group 104 is connected to the group controller 202₂ via a contactor, respectively 206₅-206₈, which can be controlled by the group controller 202₂ or by the central controller 204. Each contactor 206ᵢ can be controlled individually by the central controller 204, directly or via the group controller 202₁-202₂, in order to be set either in a closed state allowing the current provided by the module 106ᵢ to pass, or in an open state not allowing the current provided by the module 106ᵢ to pass.

The central controller 204 comprises:
a means (not shown) for measuring a remaining charge level (RCL) of each module 106 individually,
a means (not shown) for measuring a temperature of each module 106 individually, and/or
a means (not shown) for measuring a voltage at the terminals of each module 106 individually.

The central controller 204 is moreover configured for comparing each of the values measured for each module, to one or more predetermined values, or ranges of values, in order to determine whether said module is faulty or operational.

Of course, the measurement and the comparison of these parameters can alternatively be carried out by a unit other than the central controller 204, such as for example by each group controller 202₁-202₂.

FIG. 2b is a diagrammatic representation of another non-limitative example of connection in parallel of electrical energy storage modules of an electrical supply installation, and in particular of the installation 100 of FIG. 1.

The example shown in FIG. 2b comprises all the elements of the example of FIG. 2a, except for the group controllers 202.

In the example shown in FIG. 2b, the modules 106₁-106₈ are directly connected to the central controller 204 by the contactors 206₁-206₈, without using the group controllers 202₁ and 202₂. The modules 106ᵢ are then all arranged in parallel with each other.

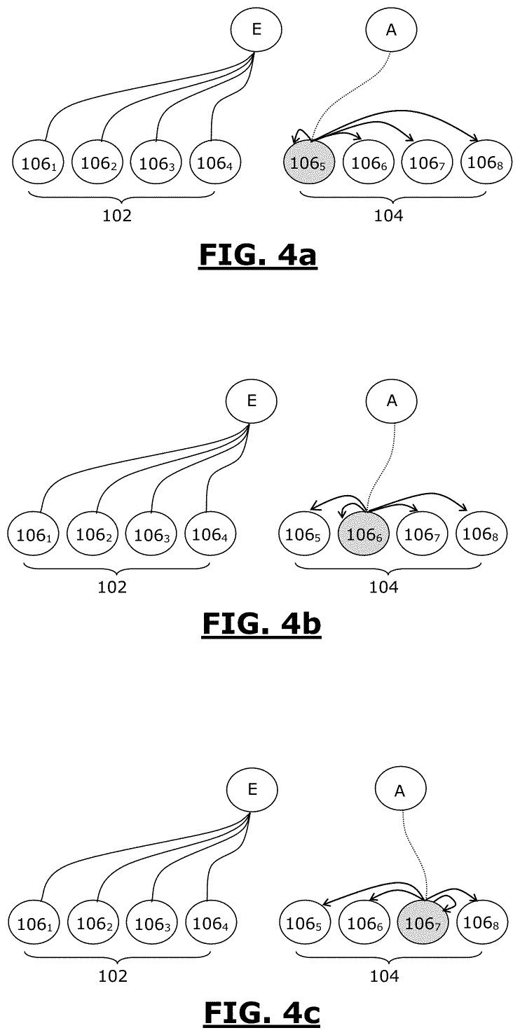

FIG. 3 is a flow chart of a first non-limitative example of a management method according to the invention.

The method 300, shown in FIG. 3, comprises a step 302 of separation of the modules into several groups, for example into exactly two groups, such as the groups 102 and 104.

During this separation step 302, the physical arrangement of the modules can be taken into account for constituting the groups, for example as shown in FIG. 2a. Alternatively, it is possible not to take into account a physical arrangement of the modules, for example as shown in FIG. 2b.

During a step 304, the method 300 produces an alternate supply from each of the groups in turn. To do this, a step 304₁ produces a supply from one of the groups. The group in the process of supplying is called active group and the other group(s) is(are) called passive group(s). The remaining charge level (RCL) of the active group is monitored during the supply step 304₁. Then, as a function of a predetermined rule, a step 304₂ produces switching of the supply to another passive group, and so on.

Switching from one group to another, during step 304₂, can be carried out as a function of the remaining charge levels (RCL) of each group and of the maximum charge capacity (MCC) of the groups.

In particular, switching from the active group to a passive group is carried out when the RCL of the active group becomes less than or equal to the RCL of a passive group of a predetermined value, which is equal to:
10% of the MCC of a group when all the groups have an RCL greater than 70% of the MCC;
8% of the MCC of a group when at least one group has an RCL comprised between 50%, and 70% of the MCC;
5% of the MCC of a group when at least one group has an RCL comprised between 30% and 50% of the MCC; and
3% of the MCC of a group when at least one group has an RCL less than 30% of the MCC.

Such switching makes it possible to optimize the discharge of all of the modules and to have a remaining charge level approximately equivalent for each module.

During the supply by an active group, the method 300 comprises a regulation phase 306 carried out within each passive group.

To do this, for each passive group, a step 306₁ produces a supply from a module of the passive group:
of a heating resistor of each module of the passive group,
and optionally, of an auxiliary device of the installation, such as
a display panel, an air-conditioning device, etc.

The module in the process of supplying the passive group is called operational module and all the other modules of the passive group are called passive modules.

The remaining charge level (RCL) of the operational module of the passive group is monitored during the supply step 306₁. Then, as a function of a predetermined rule, a step 306₂ produces a change-over of the operational module within the passive group.

The change-over of the operational module, during step 306₂, can be carried out as a function of the remaining charge levels (RCL) of each module of the passive group and of the maximum charge capacity (MCC) of a module of the passive group.

In particular, the change-over of the operational module within a passive group is carried out when the RCL of the operational module becomes less than or equal to the RCL of a module of a predetermined value, which is equal to:
5% of the MCC of a module when all the modules of the passive group have an RCL greater than 70% of the MCC;
4% of the MCC of a module when at least one module of the passive group has an RCL comprised between 50% and 70% of the MCC;
3% of the MCC of a module when at least one module of the passive group has an RCL comprised between 30% and 50% of the MCC; and
2% of the MCC of a module when at least one module of the passive group has an RCL less than 30% of the MCC.

The regulation phase 306 can be carried out for maintaining the temperature of the modules of the passive group above a predetermined value, such as for example 80° C. In this case, during the regulation phase 306, the operational module supplies the heating resistor of each module of the passive group, including its own.

In addition or alternatively, the regulation phase 306 can be carried out in order to balance the remaining charge level (RCL) of the modules of the passive group. In this case, during the regulation phase 306, the operational module can supply the heating resistor of each module of the passive group, and/or an auxiliary device external to the passive group.

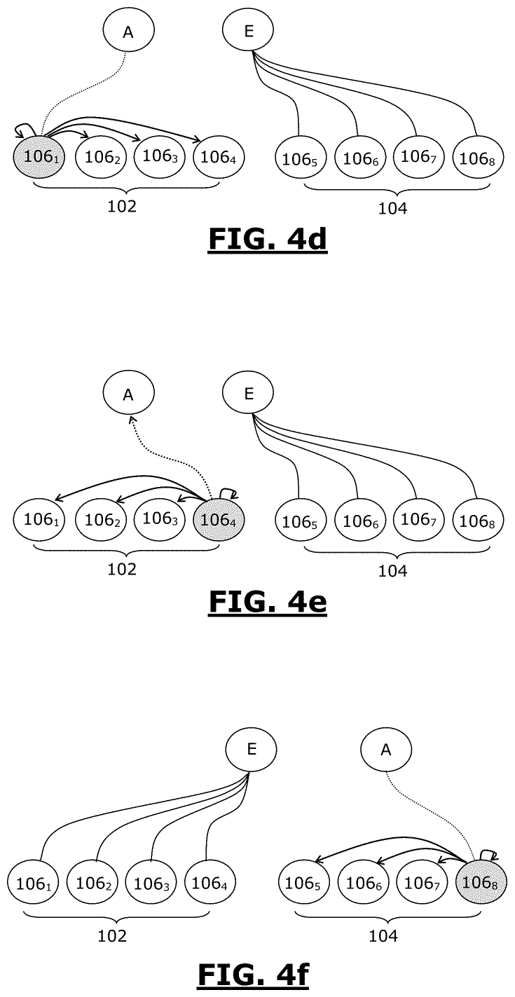

FIGS. 4a-4f are representations of an embodiment of the method 300 of FIG. 3 in the case of the installation 100 of FIG. 1.

The entity “E” is supplied alternately by the groups 102 and 104. Thus:
in FIGS. 4a-4c, the entity “E” is supplied by the group 102, then
in FIGS. 4d-4e, the entity “E” is supplied by the group 104, then
in FIG. 4f, the entity “E” is again supplied by the group 102.

With reference to FIGS. 4a-4c, the active group supplying the entity “E” is the group 102 and the group 104 is the passive group. Regulation is carried out within the passive group 104. During this regulation, all the modules 106₅-106₈ of the passive group 104, and optionally an auxiliary device denoted “A”, are supplied by a module, called operational module, chosen within passive group 104. This operational module is changed over so that:
in FIG. 4a, the operational module of the passive group 104 is the module 106₅, then
in FIG. 4b, the operational module of the passive group 104 is the module 106₆, then
in FIG. 4c, the operational module of the passive group 104 is the module 106₇.

With reference to FIGS. 4d-4e, the active group supplying the entity “E” is the group 104 and the group 102 is the passive group. Regulation is carried out within passive group 102. During this regulation, all the modules 106₁-106₄ of the passive group 102, and optionally an auxiliary device denoted “A”, are supplied by a module, called operational module, chosen within passive group 102. This operational module is changed over so that:
in FIG. 4d, the operational module of the passive group 102 is the module 106₁, then
in FIG. 4e, the operational module of the passive group 102 is the module 106₄.

With reference to FIG. 4f, the active group supplying the entity “E” is again the group 102 and the group 104 is again the passive group. Regulation is carried out within passive group 104. During this regulation, all the modules 106₅-106₈ of the passive group 104, and optionally an auxiliary device denoted “A”, are supplied by a module, called operational module, chosen within passive group 104. In FIG. 41 this operational module is the module 106₈.

Of course, the invention is not limited to the examples detailed above.

In particular, the number of storage modules, the number of groups of modules, and the number of modules for each group, are not limited to those given in the examples described above, and correspond to the maximum of energy storage modules dependent in particular on the battery life and the power desired at the level of the installation.

The invention is intended for any stationary application requiring such an installation.

1. A method for managing a plurality of rechargeable electrical energy storage modules of an electrical supply installation, said modules each comprising at least one rechargeable electrochemical battery, and being arranged in parallel with each other, said method comprising:
separating said modules into at least two groups, and
supplying from one of said groups at once;
said method comprising, during the supply by a group, called active group, a phase, called regulation phase, within at least one group, called passive group, other than the active group, said regulation phase comprising a supply of at least one module, called passive module, of said passive group by at least one other module, called operational module, of said passive group.

2. The method according to claim 1, characterized in that the regulation phase of a passive group maintains the temperature of at least one of the modules of said passive group.

3. The method according to claim 1, characterized in that the regulation phase of a passive group carries out a balancing of the remaining charge level of at least one of the modules of said passive group.

4. The method according to claim 1, characterized in that, for at least one passive group, the regulation phase comprises a change-over, of the operational module within said passive group.

5. The method according to claim 4, characterized in that the change-over is carried out as a function of the remaining charge level of each of the modules of the passive group.

6. The method according to claim 4, characterized in that the change-over is carried out when the remaining charge level of the operational module becomes less than or equal to the remaining charge level of another module of the passive group, of a first predetermined value.

7. The method according to claim 1, characterized in that it comprises a switching of the supply from one group to another, carried out when the remaining charge level of the active group is less than or equal to the remaining charge level of a passive group, of a second predetermined value.

8. The method according to claim 7, characterized in that the second predetermined value is variable as a function of the remaining charge level of each group.

9. The method according to claim 1, characterized in that each group comprises one and the same number of modules.

10. The method according to claim 9, characterized in that the operational module of the passive group is used for the supply of an auxiliary device within the installation.

11. A system for managing a plurality of rechargeable electrical energy storage modules of an electrical supply installation, said modules each comprising at least one rechargeable electrochemical battery, and being arranged in parallel with each other, said system comprising:
for each module, a means of individual connection/disconnection, making it possible to discharge said module independently of the other modules, and
at least one controller for controlling, directly or indirectly, each of said means of connection/disconnection;
said controller being configured for implementing all of the steps of the method according to claim 1.

12. An electrical supply installation comprising a plurality of rechargeable electrical energy storage modules, said modules each comprising at least one rechargeable electrochemical battery, and being arranged in parallel with each other, said modules being managed:
according to a method for managing a plurality of rechargeable electrical energy storage modules of an electrical supply installation, said modules each comprising at least one rechargeable electrochemical battery, and being arranged in parallel with each other, said method comprising:
separating said modules into at least two groups, and
supplying from one of said groups at once;
said method comprising, during the supply by a group, called active group, a phase, called regulation phase, within at least one group, called passive group, other than the active group, said regulation phase comprising a supply of at least one module, called passive module, of said passive group by at least one other module, called operational module, of said passive group; or
by the system according to claim 11.

13. The installation according to claim 12, characterized in that it comprises a means for producing electrical energy from a renewable source, such as at least one solar panel and/or a wind turbine.

14. The installation according to claim 12, characterized in that it is:
a station for the electrical recharging of electric vehicles, or
an electrical supply installation for a building, a complex or an electric/electronic communication device.
